(19) United States
(12) Patent Application Publication
(10) Pub. No.: US 2010/0328801 A1
(43) Pub. Date: Dec. 30, 2010

(54) DISK DRIVE

(75) Inventor: Keiichi YORIMITSU, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/819,121

(22) Filed: Jun. 18, 2010

(30) Foreign Application Priority Data
Jun. 26, 2009 (JP) 2009-152962

(51) Int. Cl. G11B 27/36

(52) U.S. Cl. 360/31; G9B/27.052

(57) ABSTRACT

According to one embodiment, a disk drive includes a disk medium, a read controller configured to perform a read control for information in the disk medium, a determiner configured to determine whether or not to ignore a read error in information as a read target depending on a type of the information, and a transmitter configured to transmit the information to a host device without read error detection for the information read by the read controller if the determiner determines to ignore the read error.

### CROSS-REFERENCE TO RELATED APPLICATIONS

This application is based upon and claims the benefit of priority from Japanese Patent Application No. 2009-152962, filed Jun. 26, 2009, the entire contents of which are incorporated herein by reference.

### BACKGROUND

1. Field

One embodiment of the invention relates to a disk drive that controls reading of information from a disk medium.

2. Description of the Related Art

Conventionally, in a device configured to access a disk to read or write data, an error may occur. When an error occurs, various controls are performed depending on the situation.

For example, when a read error occurs in a hard disk drive, retry control is generally performed to completely read the data. However, with this retry control, data transmission is naturally delayed. Therefore, depending on a type of data to be read, delay of data transmission due to the retry control may affect more than incomplete reading of data in one sector in a bit level.

The delay largely affects particularly when data to be read is movie data. The reason is that with respect to movie data, even if data of almost an amount corresponding to one sector (standard: 512 Bytes) cannot be read, as long as data around the missing data can be read, the image data deteriorates merely to a level not to cause any disadvantage for human vision (level to cause flickering of an image). On the other hand, if retry for the magnetic disk is repeated in order to completely read data of one sector, data transmission is delayed and eventually, image display may stop or slow down.

As a technology to suppress delay of data access, a technology disclosed in Japanese Patent Application Publication (KOKAI) No. 2000-112674 is known. In Japanese Patent Application Publication (KOKAI) No. 2000-112674, image files and management numbers for managing reproduction order for controlling the image files are stored, and even when many defect regions exist on an information recording medium, continuous recording is allowed stably without affected by the defect regions. Specifically, by managing regions appropriately, continuous recording and reproduction of image data are allowed even when defect regions exist. However, even when the technology is utilized, if an error occurs upon reading data from a region managed using the management number, retry is repeated, as conventionally done.

A function to suppress the delay of data transmission due to the repeated retry is conventionally provided on a hard disk drive. The function is generally called Read Continuous (RC) function and defined in ANSI rule (SCSI Block Commands-3 (SBC-3)).

With the RC function utilized, when a host instructs to set the RC function effective, data can be transmitted as it is to the host while ignoring read errors even if read errors occur upon sector reading.

However, in the technology described above, when the RC function is set effective, data is transmitted to the host without retry for all user data on the magnetic disk. Such a process does not have disadvantage for movie data and the like. However, various types of data such as control information for managing or identifying image data (file system information, for example) is usually stored in a magnetic disk together with the movie data. The control information is information that does not allow an error in bit level. Therefore, when read errors occur upon reading of control information, the device performs internal retry appropriately and only if the read errors can be recovered by the retry, the device transmits the data and allocates an alternate sector. If read errors cannot be recovered, the device reports an error.

As described above, it is required to switch whether or not to perform retry depending on a type of data. Although this may be realized by changing the RC function to be effective or ineffective depending on a type of data by the host, management method would be complicated.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of a structure of a disk drive according to a first embodiment of the invention;

FIG. 2 is an exemplary schematic view illustrating a structure of a disk medium in the first embodiment;

FIG. 3 is an exemplary diagram illustrating one specific example of a structure of a sector in the first embodiment;

FIG. 4 is an exemplary diagram illustrating a software configuration of the first embodiment that can be realized by an MPU that has read a firmware program in the first embodiment;

FIG. 5 is an exemplary schematic view illustrating regions allocated for each of zones of a disk medium in the first embodiment;

FIG. 6 is an exemplary table of conditions used by a determiner as basis of determining whether or not to ignore read error in the first embodiment;

FIG. 7 is an exemplary flowchart illustrating a process upon reading data when RC function is set to 1 in a hard disk drive in the first embodiment;

FIG. 8 is an exemplary diagram illustrating a software configuration that can be realized by an MPU that has read a firmware program according to a second embodiment of the invention;

FIG. 9 is an exemplary diagram illustrating a plurality of disk media provided in a hard disk drive and cylinders in the disk media in the second embodiment;

FIG. 10 is an exemplary schematic view illustrating regions assigned to respective cylinders of the disk media in the second embodiment;

FIG. 11 is an exemplary diagram illustrating a software configuration that can be realized by an MPU that has read a firmware program according to a third embodiment of the invention; and

FIG. 12 is an exemplary flowchart illustrating a process upon reading data in a hard disk drive in the third embodiment.

### DETAILED DESCRIPTION

Various embodiments according to the invention will be described hereinafter with reference to the accompanying drawings. In general, according to one embodiment of the invention, a disk drive comprises: a disk medium; a read controller configured to perform a read control for information in the disk medium; a determiner configured to determine whether or not to ignore a read error in information as a read target depending on a type of the information; and a transmitter configured to transmit the information to a host device without read error detection for the information read by the read controller if the determiner determines to ignore the read error.

Various embodiments of a disk drive of the invention will be described hereinafter with reference to the accompanying drawings. The invention is not limited to the embodiments.

### FIRST EMBODIMENT

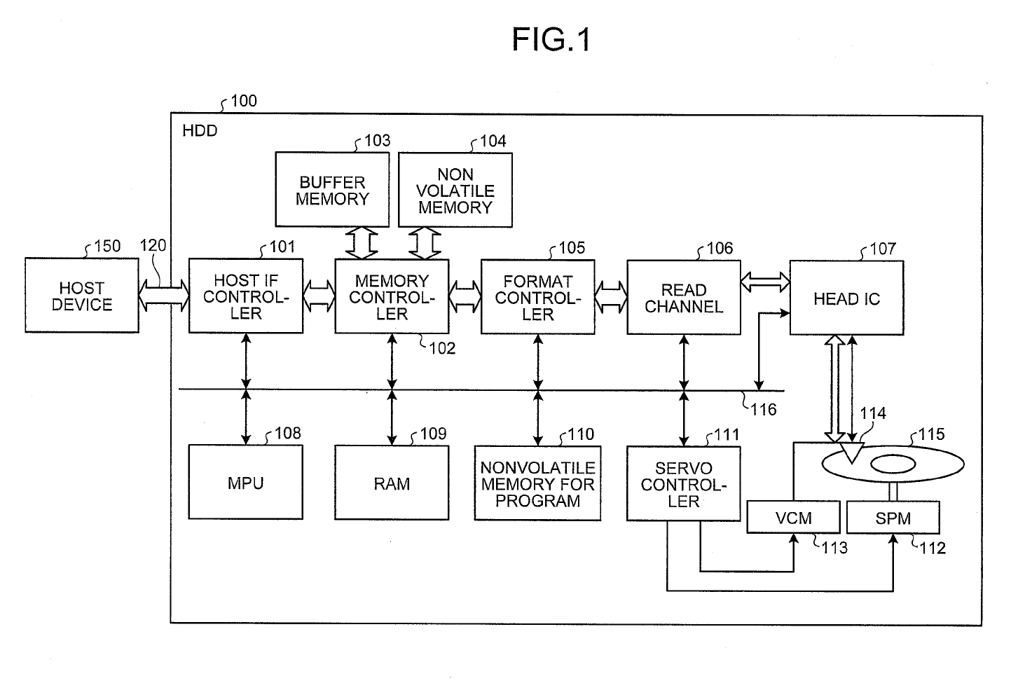

FIG. 1 illustrates a structure of a disk drive according to a first embodiment of the invention. FIG. 1 is a block diagram illustrating a structure of inside of a hard disk drive 100 according to the first embodiment. As illustrated in FIG. 1, the hard disk drive 100 comprises: a host interface controller 101; a memory controller 102; a buffer memory 103; a nonvolatile memory 104; a format controller 105; a read channel 106; a head IC 107; an MPU 108; a RAM 109; a nonvolatile memory for program 110; a servo controller 111; an SPM 112; a VCM 113; a head 114; a disk medium 115; and a common bus 116. The hard disk drive 100 is connected to a host device 150.

The host interface controller (maybe referred to as host IF controller) 101 is connected to the host device 150 through a host IF 120 to control communication with the host device 150. The common bus 116 connects each of processing modules in the hard disk drive 100 to serve as a bus for exchanging various information between the processing modules.

The buffer memory 103 temporarily stores information exchanged between the host device 150 and the hard disk drive 100 and the like. Data stored in the buffer memory 103 is output to the host device 150.

The nonvolatile memory 104 stores data comprising setting information that is desired to be maintained even when the power of the hard disk drive is down.

The memory controller 102 controls the buffer memory 103 and the nonvolatile memory 104 according to instructions input from the MPU 108.

The voice coil motor (VCM) 113 is a head driving mechanism driven by the servo controller 111 and rotates an arm above the disk medium 115. The spindle motor (SPM) 112 is a mechanism driven by the servo controller 111 to rotate the disk medium 115.

The servo controller 111 drives the VCM 113 and the SPM 112 according to instructions input from the MPU 108.

The head 114 maintains a state flying slightly above a surface of the disk medium 115 by lift force generated by rotation of the disk medium 115 to read/write data. The head 114 may be a read head to read data or a write head to write data.

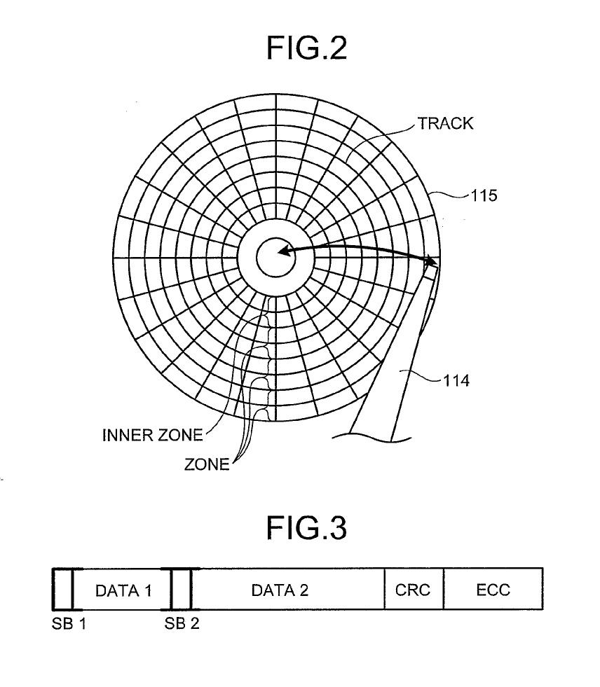

The disk medium 115 comprises a data region from/to which data can be read or write. FIG. 2 is a schematic view illustrating a structure of the disk medium 115. As illustrated in FIG. 2, the disk medium 115 comprises a track at each of various diameters. As illustrated in FIG. 2, a region (data region) for recording data transmitted from a host system is arranged on each of the tracks. The data region is constituted by a plurality of sectors. Each of the sectors is the minimum unit of data that is written to the disk medium 115.

The disk medium 115 is constituted by a plurality of zones and each of the zones comprises a plurality of tracks. In the first embodiment, in the zones constituting the disk medium, at least one zone on the inner side is called an inner zone. In the disk medium 115 of the first embodiment, depending on a type of information to be stored, a zone in which the information is stored is selected differently as to be specifically explained later.

When the head 114 moves in a radial direction of the disk medium 115, the head 114 can scan any sector on any track. The head 114 scans sectors on the disk medium 115 so that data can be read and written.

All sectors comprised in each of the tracks, even in zones for storing different types of data, have the same format. FIG. 3 illustrates one specific example of a structure of a sector. As illustrated in FIG. 3, a usual sector of the disk medium 115 is divided into the regions for sync byte (SB), User Data, Cyclic Redundancy Check (CRC), and Error Correcting Code (ECC).

The SB (SB 1 and SB 2) is a region from which a signal indicating start of the User Data (Data 1 and Data 2) is read. The User Data (Data 1 and Data 2) is a region where user data is stored. The CRC is a region in which data for checking consistency of data is stored. The ECC is a region in which ECC information for correcting errors comprised in usual sector data is stored.

Referring to FIG. 1 again, the format controller 105 performs error check and the like on data transmitted between the host device 150 and the hard disk drive 100. For example, upon reading data, the format controller 105 receives data from the read channel 106, appropriately performs error correction, and outputs the data to the memory controller 102.

The read channel 106 performs AD conversion, and modulation/demodulation on data transmitted between the host device 150 and the hard disk drive 100. For example, upon reading data, the read channel 106 performs predetermined processes such as amplification, AD conversion, and demodulation on data signals output from the head IC 107. For example, upon writing data, the read channel 106 modulates data input from the format controller 105.

The RAM 109 is a memory used by the MPU 108 as a working region and for example, stores data for control, a firmware program, and the like read by the MPU 108.

The nonvolatile memory for program 110 is a memory (FROM) for storing a firmware program read by the MPU 108.

The MPU 108 performs a main control of the hard disk drive 100 according to the firmware program. Specifically, the MPU 108 interprets a command from the host device 150 to control each of the processing modules, thereby integrally controls read/write operation of data on the disk medium 115. The MPU 108 may be a Micro Controller Unit (MCU) or a Central Processing Unit (CPU).

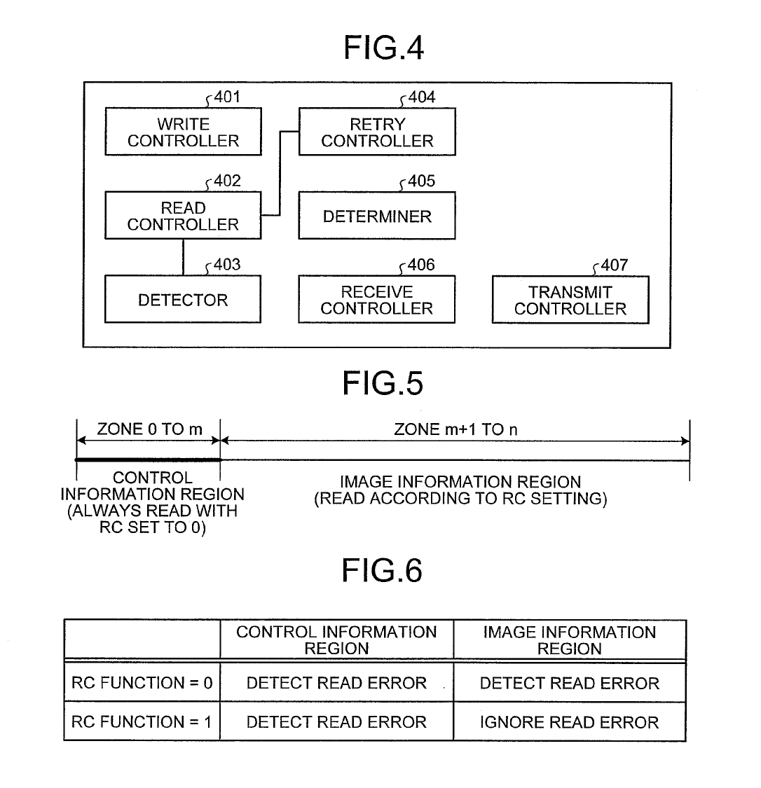

Processes by the MPU 108 in the first embodiment are specifically explained. FIG. 4 illustrates a software configuration of the first embodiment that can be realized by the MPU 108 that has read a firmware program.

As illustrated in FIG. 4, in the hard disk drive 100, the MPU 160 that has read the firmware program realizes a configuration comprising a write controller 401, a read controller 402, a detector 403, a retry controller 404, a determiner 405, a receive controller 406, and a transmit controller 407.

According to the firmware program for the hard disk drive 100 of the first embodiment, whether or not data should be read according to an RC function is determined based on a physical position of the disk medium 115 from which data is read. Specifically, for a region in which data causing no disadvantage even when missed to some extent such as image data is stored, a read control is performed according to the RC function, and for a region in which data that does not allow an error in bit level (for example, control information) is stored, read error detection is always performed while ignoring the RC function.

In the first embodiment, “the RC function is set to be effective” means that a setting is made in such a manner that retry is not performed while ignoring read errors.

Specifically, in the first embodiment, when the RC function is set to be effective, read errors are ignored according to the RC function for a region in which image data and the like is stored. On the other hand, even when the RC function is set to be effective, read error detection is performed while ignoring the RC function for a region in which data that does not allow an error in bit level (for example, control information) is stored.

In the first embodiment, “the RC function is set to be effective” indicates a case where ‘1’ is set for the RC function and “the RC function is not set” indicates a case where ‘0’ is set for the RC function.

In the disk medium 115 of the hard disk drive 100 according to the first embodiment, whether or not to ignore the RC function for the region is previously set for each of the zones.

FIG. 5 is a schematic view illustrating regions assigned to the respective zones of the disk medium 115 according to the first embodiment. In the example illustrated in FIG. 5, the disk medium 115 is constituted by zones ‘0’ to ‘n’. In these zones, to zones ‘0’ to ‘m’ that are inner zones, control information regions are assigned and to other zones ‘m+1’ to ‘n’, image information regions are assigned. Where m is an integer smaller than n.

In the control information regions, data that does not allow an error in bit level such as control information is stored. In the image information regions, various user data such as image data is stored. In the first embodiment, a storage region in the disk medium 115 is selected differently depending on a type of data. Next, processes performed by the respective processing modules are explained.

The receive controller 406 instructs the host IF controller 101 so as to perform a receive control of data or instructions from the host device 150. The received data may be temporarily stored in the buffer memory 103 as needed through the control by the memory controller 102.

The transmit controller 407 instructs the host IF controller 101 so as to perform a transmit control of data to the host device 150.

The write controller 401 instructs the servo controller 111 to control the writing to the disk medium 115. Data to be written by a write control is data received together with a write instruction from the host device 150. Data temporarily stored in the buffer memory 103 is also subjected to the write control.

When the write controller 401 according to the first embodiment receives, from the host device 150, an instruction to write data to a Logical Block Address (LBA) corresponding to a portion in the control information region, the write controller 401 performs a control to write data in the control information region that are inner zones of the disk medium 115. With respect to other data, the write controller 401 performs a write control to write data to another region (image information region) indicated by the LBA received together with the write instruction.

The read controller 402 instructs the servo controller 111 so as to perform a read control of data from the disk medium 115 through the read channel 106.

When data is read from the disk medium 115, the determiner 405 determines whether or not to ignore read errors of the data. In the first embodiment, depending on whether or not the zone from which data is read is an inner zone and depending on whether the RC function is set to be effective or ineffective, the determiner 405 determines whether or not to ignore read errors.

When the determiner 405 determines to ignore read errors, the detector 403 does not perform read error detection on the data read by the read controller 402. Specifically, when the determiner 405 determines to ignore read errors, the host IF controller 101 performs a transmit control on the read data according to an instruction from the transmit controller 407 without detecting read errors.

FIG. 6 is a table of conditions used by the determiner 405 as basis of determining whether or not to ignore read errors. As provided in FIG. 6, if the RC function is set to be effective (RC function is set to 1) and if data is read from the image information region, the determiner 405 determines to ignore read errors. If the RC function is set to be ineffective (RC function is set to 0) or if data is read from the control information region, the determiner 405 determines to detect read errors. That is, in the hard disk drive 100 according to the first embodiment, when data is read from the control information region, the read control is performed assuming that the RC function is always set to 0 without affected by the RC function previously set.

For example, while data is read from the image information region, if the host device 150 sets the RC function to be effective at the time of performance degradation due to many read errors, only the data read from the image information region is not subjected to retry.

Here, the RC function can be set to be effective or ineffective in a uniform way by a command defining a control on the device side such as a Mode Select command according to ANSI rule, and thus the explanation thereof is not provided.

Referring to FIG. 4 again, when the determiner 405 determines not to ignore read errors, the detector 403 performs read error detection on the data read through a read control by the read controller 402.

If the detector 403 detects a read error, the retry controller 404 performs a read retry control on the read controller 402 for the data in which the read error is detected.

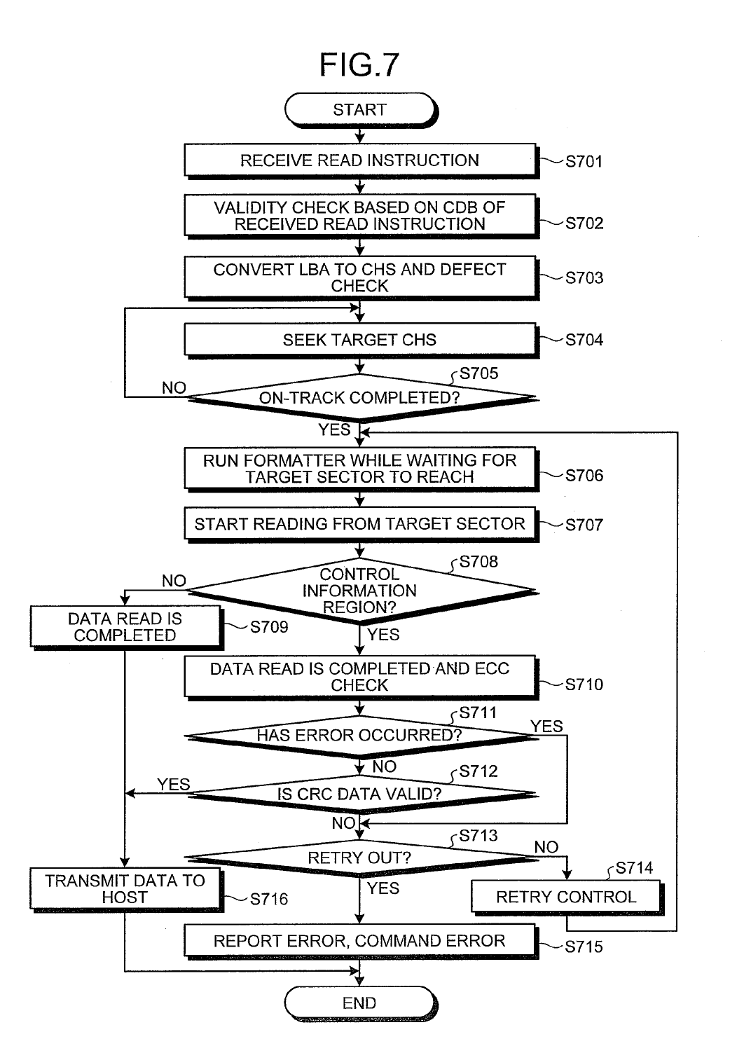

Next, processing procedures upon read are explained. FIG. 7 is a flowchart illustrating a process upon reading data when the RC function is set to 1 in the hard disk drive 100 of the first embodiment. As described above, for the processing procedures illustrated in FIG. 7, it is assumed that the RC function is already set to 1.

First, the receive controller 406 controls the host IF controller 101 to receive a read instruction from the host device 150 (S701).

Then, the receive controller 406 checks validity of each of parameters stored in a Command Descriptor Block (CDB) provided with the received read instruction (S702).

The read controller 402 converts a Logical Block Address (LBA) that is indicated as a read target in the received read instruction to Cylinder/Head/Sector (CHS) and then performs a defect check (check if the read target is a defect region or not) on the CHS (S703). If the CHS is a defect region, the read controller 402 controls to skip the defect region and to read from a normal region.

The read controller 402 controls the servo controller 111 so that the head 114 seeks the target CHS (S704).

The servo controller 111 judges if on-track of the head 114 is completed (S705). If it is determined that on-track is not completed (No at S705), the control of S704 is repeated.

On the other hand, if the servo controller 111 judges that on-track of the head 114 is completed (Yes at S705), the format controller 105 runs a formatter while waiting for the target sector to reach the position of the head 114 (S706).

The read controller 402 instructs to start reading so that the head IC 107 starts reading from the target sector (S707).

The determiner 405 judges whether the sector, from which data is read, is a control information region or not (S708).

If the determiner 405 judges that the sector is not a control information region (No at S708), the determiner 405 determines not to perform the read error detection or the retry control because the RC function is set to 1. The head IC 107 completes reading data from the target sector (S709). At this time, ECC check and the like are not performed based on the determination in S708.

The transmit controller 407 controls the host IF controller 101 to transmit the read data to the host device 150 (S716).

On the other hand, if the determiner 405 judges that the sector is a control information region (Yes at S708), the determiner 405 determines to always perform the read error detection and the retry control even though the RC function is set to 1. After the head IC 107 completes reading data from the target sector, the read controller 402 performs the ECC check on the read data (S710).

The read controller 402 judges whether or not an error occurs through the ECC check (S711). If the read controller 402 judges that an error has not occurred (No at S711), the read controller 402 judges whether or not the CRC data is valid (S712). If the read controller 402 has judges that the CRC data is valid (Yes at S712), the transmit controller 407 controls the host IF controller 101 to transmit the read data to the host device 150 (S716).

On the other hand, if the read controller 402 judges that an error has occurred (Yes at S711) or that the CRC data is not valid (No at S712), the retry controller 404 judges whether or not a retry-out condition is satisfied (S713).

If the retry controller 404 judges that the retry-out condition is not satisfied (No at S713), the retry control is performed so as to read data from the target sector again according to a control by the retry controller 404 (S714). Then, the process continues again from S706.

On the other hand, if the retry controller 404 judges that the retry-out condition is satisfied (Yes at S713), the retry controller 404 controls the transmit controller 407 to report the error to the host device 150 and then terminates the process as a command error (S715). Accordingly, the transmit controller 407 reports the host device 150 that an error has occurred upon reading.

In the hard disk drive 100, after the data is transmitted to the host device 150 in S716, a sector read is successively performed, or the process ends when all sector reads are completed.

In the first embodiment, according to the processing procedures described above, the read error detection is performed on data stored in control information regions even when the RC function is set to 1, and thus a highly accurate read process can be performed whilst delay of data transmission can be suppressed for the image information regions.

In conventional processing procedures, if the RC function is set to 0, an ECC check and a data validation check based on a CRC is performed on all data that is read, and if the RC function is set to 1, the ECC check and the data validation check based on the CRC is not performed on any data. Therefore, when the RC is set to 1, an error is more likely to be present in control information, and when the RC is set to 0, data transmission of image data is likely to be delayed. In other word, reading is performed without distinction of information. Accordingly, a process appropriate for a certain type of information may be inappropriate for another type of information.

In contrast, in the hard disk drive 100 of the first embodiment, physical positions in which the control information is stored, in which the image information and the like is stored, are selected differently, and based on the position, from which data is to be read, reading process is switched. Therefore, reading control appropriate for each type of information can be performed.

In the first embodiment, a control information region or an image information region is assigned to each of the zones. However, not limited to each of the zones, the information may be assigned to each of the tracks or each of the cylinders.

As described above, according to the first embodiment, when a movie file or an image file that allows read errors to some extent, and control information that does not allow read errors both exist on a disk medium, and even when quality of the disk is low, control information can be appropriately managed while suppressing the performance degradation of movie reproduction to the minimum. With such a configuration, the disadvantage due to the uniform control can be eliminated, and thus the RC function can be used more easily and broadly and control quality based on control information that does not allow missing of data in bit level can be maintained.

### SECOND EMBODIMENT

In the first embodiment as described above, information to be stored in the zones is respectively determined previously. However, regions in which the control information is stored are not necessarily determined previously, and the regions may be changed by instructions from the host device 150. In a second embodiment of the invention, a case where the control information regions may be changed by instructions from the host device 150 is explained.

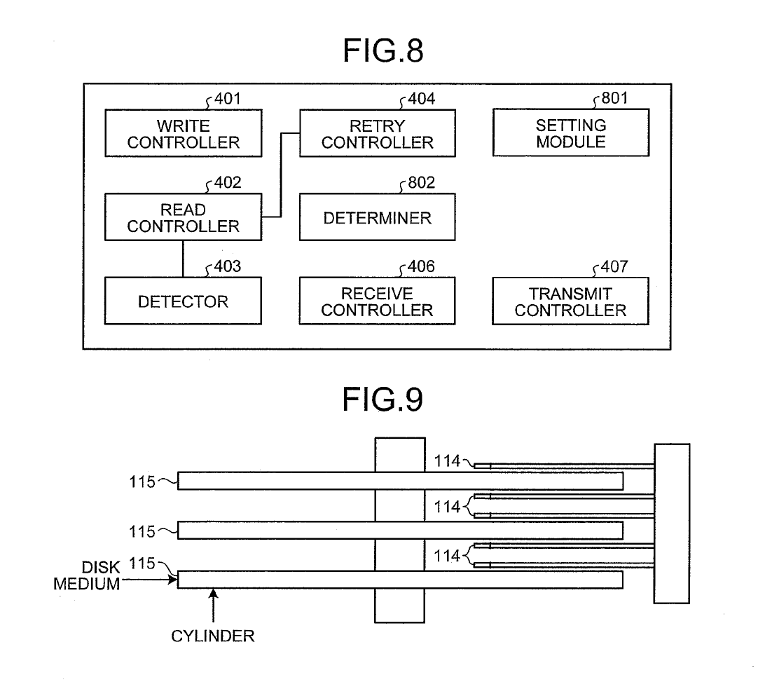

FIG. 8 illustrates a software configuration of the second embodiment that can be realized by the MPU 108 of a hard disk drive that has read a firmware program.

As illustrated in FIG. 8, in the hard disk drive according to the second embodiment, the MPU 108 that has read the firmware program realizes a configuration comprising the write controller 401, the read controller 402, the detector 403, the retry controller 404, a determiner 802, the receive controller 406, the transmit controller 407, and a setting module 801. The second embodiment is different from the first embodiment in that the setting module 801 is added and that the determiner 405 is replaced with the determiner 802 performing a process different from that performed by the determiner 405. In the following explanation, components that are identical to those in the first embodiment are indicated by the same reference numerals and explanation thereof is not repeated.

Whilst a type of region is set to each of the zones in the first embodiment, a control information region or an image information region is assigned to each of the cylinders in the second embodiment.

FIG. 9 illustrates a plurality of disk media 115 provided in the hard disk drive according to the second embodiment and cylinders in the disk media 115. As illustrated in FIG. 9, each surface of each of the disk media 115 is defined as a cylinder. In the second embodiment, cylinders ‘0’ to ‘n’ are provided.

When the receive controller 406 receives, from the host device 150, a change instruction indicating the cylinder which is to be a control information region, the setting module 801 sets the cylinder as a control information region based on the change instruction.

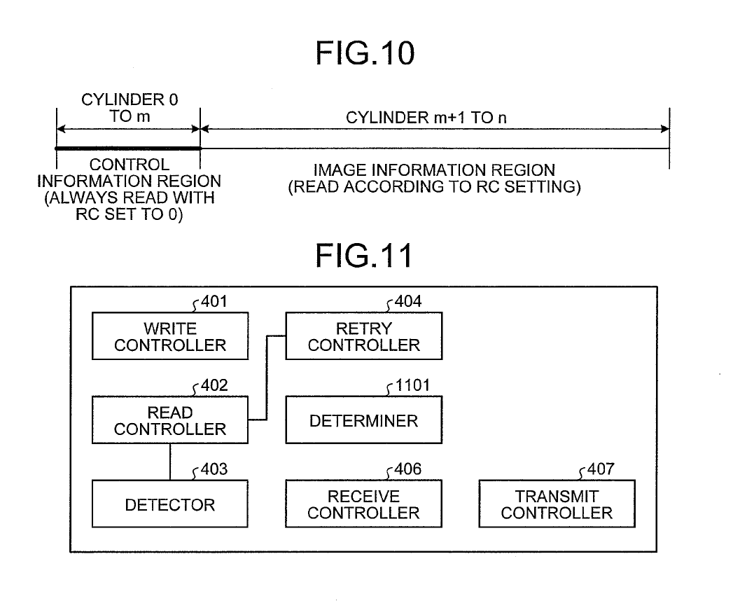

FIG. 10 is a schematic view illustrating regions assigned to respective cylinders of the disk media 115. In the example illustrated in FIG. 10, the disk media 115 are constituted by cylinders ‘0’ to ‘n’. In these cylinders, to cylinders ‘0’ to ‘m’, control information regions are assigned and to other cylinders ‘m+1’ to ‘n’, image information regions are assigned. Where m is an integer smaller than n.

The setting module 801 controls the memory controller 102 to write information indicating a correspondence relation between the cylinders and the regions to the nonvolatile memory 104. Accordingly, with reference to the nonvolatile memory 104, a region assigned to each of the cylinders can be identified as a control information region or an image information region. When the setting is not yet made by the setting module 801, as an initial state, control information regions are assigned to previously determined cylinders.

The host device 150 which knows the data types and the correspondence relation between the respective cylinders and the regions gives an instruction on an address (LBA) as a write target of each data together with a write instruction. Accordingly, the write controller 401 can write data of a type appropriate for each of the cylinders to which a control information region or an image information region is assigned.

When the determiner 802 reads data from the disk media 115, the determiner 802 refers to the correspondence relation between the respective cylinders and the regions stored in the nonvolatile memory 104 through the memory controller 102 so as to determine whether or not to ignore read errors in read data. Specifically, the determiner 802 determines whether or not to ignore read errors depending on whether or not a cylinder, in which the read data is stored, is a control information region or not.

In the second embodiment, a control information region or an image information region is assigned to each of the cylinders. However, not limited to each of the cylinders, the information may be assigned to each of the zones, for example.

As described above, according to the second embodiment with the configuration described above, the control information region can be changed on cylinder basis, according to the instructions from the host device 150, and the read control can be performed appropriately for each region. Specifically, in the second embodiment, in addition to the effect described for the first embodiment, the size of the control information regions can be changed corresponding to data to be stored, whereby data can be effectively stored.

### THIRD EMBODIMENT

In the first and second embodiments as described above, whether or not to perform the error detection and the like is determined based on a position in which data is stored. However, the basis for switching whether or not to perform the error detection and the like is not limited to a position in which data is stored, and may be a type of data to be read. In a third embodiment of the invention, whether or not to perform the error detection and the like is switched based on data stored in a CRC associated with an instruction from the host device 150.

Conventionally, the RC function is set to be effective or ineffective in a uniform way by a command defining a control on the host device 150 side such as a Mode Select command according to ANSI rule.

However, since the host device 150 transmits read instructions, the host device 150 knows the type of data to be read (control information or image information). Considering the fact, by setting the RC function for each of read instructions rather than each of commands, the RC function can be switched to effective or ineffective more flexibly.

Therefore, in the third embodiment, the host device 150 is allowed to issue a read instruction provided with an RC function setting, and a hard disk drive determines whether or not to perform retry depending on the RC function setting provided for the read instruction.

In the third embodiment, by defining an RC bit in a (8, 12, 16 or 32 Bytes of) Command Descriptor Block (CRC) comprised in each read instruction, the RC function can be set to be effective or not.

FIG. 11 illustrates a software configuration of the third embodiment that can be realized by the MPU 108 that has read a firmware program.

As illustrated in FIG. 11, the hard disk drive of the third embodiment is different from the first embodiment in a point that the determiner 405 is replaced with a determiner 1101 performing a process different from that performed by the determiner 405. In the following explanation, components that are identical to those in the first embodiment are indicated by the same reference numerals and explanation thereof is not repeated.

When the determiner of the third embodiment reads data from the disk medium 115, the determiner 1101 determines whether or not to ignore read errors based on a CRC provided for a read instruction received by the receive controller 406.

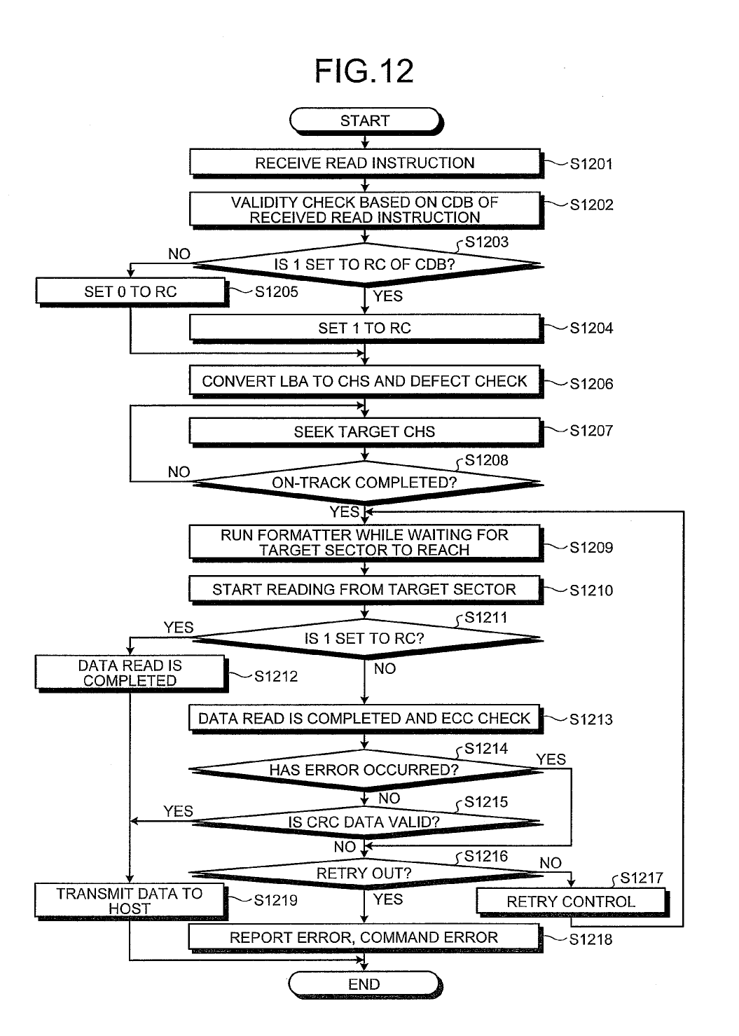

Next, processing procedures upon read in the third embodiment are explained. FIG. 12 is a flowchart illustrating a process upon reading data in the hard disk drive of the third embodiment.

First, the receive controller 406 controls the host IF controller 101 to receive a read instruction from the host device 150 (S1201).

Then, the receive controller 406 checks validity of each of parameters stored in a Command Descriptor Block (CDB) provided for the received read instruction (S1202).

Then, the determiner 1101 judges whether or not ‘1’ is set to an RC parameter stored in the CDB (S1203). If the determiner 1101 judges that ‘1’ is set to the RC parameter (Yes at S1203), the determiner 1101 sets ‘1’ for the RC function (S1204).

If the determiner 1101 judges that ‘0’ is set to the RC parameter (No at S1203), the determiner 1101 sets ‘0’ for the RC function (S1205).

The read controller 402 converts a Logical Block Address (LBA) that is indicated as a read target in the received read instruction to Cylinder/Head/Sector (CHS) and then performs a defect check (check if the read target is a defect region or not) on the CHS (S1206). If the CHS is a defect region, the read controller 402 controls to skip the defect region and to read from a normal region.

The read controller 402 controls the servo controller 111 so that the head 114 seeks the target CHS (S1207).

The servo controller 111 judges if on-track of the head 114 is completed (S1208). If it is determined that on-track is not completed (No at S1208), the control of S1207 is repeated.

On the other hand, if the servo controller 111 judges that on-track of the head 114 is completed (Yes at S1208), the format controller 105 runs the formatter while waiting for the target sector to reach the position of the head 114 (S1209).

The read controller 402 instructs to start reading so that the head IC 107 starts reading from the target sector (S1210).

Then, the determiner 1101 judges whether ‘1’ is set for the RC function or not (S1211).

If the determiner 1101 judges that ‘1’ is set for the RC function (Yes at S1211), the determiner 1101 determines not to perform the read error detection or the retry control. The head IC 107 completes reading data from the target sector (S1212). At this time, ECC check and the like is not performed based on the determination in S1211.

The transmit controller 407 controls the host IF controller 101 to transmit the read data to the host device 150 (S1216).

On the other hand, if the determiner 1101 judges that ‘1’ is not set for the RC function (RC feature=0, No at S1211), the determiner 1101 determines to always perform the read error detection and the retry control. After the head IC 107 completes reading data from the target sector with such control, the read controller 402 performs the ECC check on the read data (S1213). Thereafter, the process continues similarly to S711 to S716 of the first embodiment and then ends (S1214 to S1219).

As described above, in the third embodiment, the RC function can be switched for each read instruction. In other word, the RC function can be switched for each piece of data to be read and thus a read process appropriate for each piece of data is possible.

In the third embodiment, with respect to the control information, data can be read without any missing of data in bit level. At the same time, with respect to data that is required to be read quickly such as the image data, retry is not performed so that high speed data reading is possible.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk drive comprising:
a disk medium;
a read controller configured to read information in the disk medium;
a determining controller configured to determine whether to ignore a read error in information as a read target depending on the content of the information; and
a transmitter configured to transmit the information to a host device without read error detection for the read information if the determination controller determines to ignore the read error.

2. The disk drive of claim 1, wherein
a physical position storing the information in the disk medium depends on the content of the information, and
the determination controller is configured to determine whether to ignore a read error in the information based on the physical position of the read target.

3. The disk drive of claim 2, wherein
the determination controller is configured to determine not to ignore a read error in the information if a Read Continuous (RC) function is not configured to retry reading, and if a physical position storing the information to be read is a region for retry reading, and
the disk drive comprises:
a detector configured to detect a read error on the read information; and
a retry controller configured to retry reading the information when the detector detects a read error.

4. The disk drive of claim 3, wherein
the transmitter is configured to transmit to the host device, a report of an error upon reading when the information has not been correctly read with the retry reading by the retry controller.

5. The disk drive of claim 2, further comprising a setting module configured to set, for each physical position on the disk medium, of whether to ignore a read error in information in the position.

6. The disk drive of claim 5, the determination controller is further configured to determine to ignore the read error in the read information from a previously set physical position wherein when the setting module is not set to ignore the read error.

7. The disk drive of claim 1, further comprising a receiver configured to receive a read instruction for information, wherein the determination controller is configured to determine whether to ignore a read error in the information depending on a flag indicating whether to ignore a read error for the received instruction.

8. The disk drive of claim 7, further comprising:
a detector configured to detect a read error on the read information when the determination controller determines not to ignore a read error in the read information; and
a retry controller configured to retry reading the information when a read error is detected by the detector.

9. The disk drive of claim 8, wherein
the transmitter is configured to transmit to the host device, a report of an error upon reading when the information has not been correctly read with the retry reading by the retry controller.

10. The disk drive of claim 1, wherein the determining controller is configured to determine to ignore a read error in the information if the content of the information with the read error is recoverable.

11. The disk drive of claim 10, wherein the content of the information is image data.

12. The disk drive of claim 1, wherein the content of the information is control information.
